(19) United States
(12) Patent Application Publication
(10) Pub. No.: US 2017/0343034 A1
(43) Pub. Date: Nov. 30, 2017

(54) SECURING ELEMENT AND SECURING SYSTEM

(71) Applicant: Zollmann GmbH, Burladingen (DE)

(72) Inventor: Martin ZOLLMANN, Burladingen (DE)

(73) Assignee: Zollmann GmbH, Burladingen (DE)

(21) Appl. No.: 15/524,669

(22) PCT Filed: Oct. 30, 2015
(86) PCT No.: PCT/DE2015/100456

§ 371 Date: May 5, 2017

(30) Foreign Application Priority Data
Nov. 6, 2014 (DE) 10 2014 116 227.7

(51) Int. Cl. F16B 39/04; F16B 39/12; F16B 39/08; F16B 39/282; B60B 3/16

(52) U.S. Cl. CPC F16B 39/04; F16B 39/12; F16B 39/08; B60B 3/165; F16B 39/282

(57) ABSTRACT

In a securing element for connecting two parts, in particular for a screw connection, the securing element is ring-shaped. The securing element has an outer profile along the outer diameter and an inner profile along the inner diameter. The outer profile and the inner profile are both formed by a plurality of profile units. The number of profile units of the outer profile and the number of profile units of the inner profile correspond to the number of graduation marks at different scales according to the principle of a vernier scale, the number of profile units of the outer profile differing by at least 1 from the number of profile units of the inner profile. In precisely one position, a profile unit of the outer profile is exactly opposite a profile unit of the inner profile.

The present invention relates to a securing element and a securing system for connecting two components, in particular for a screw connection, and preferred uses of this securing system.

### PRIOR ART

Screw or bolt connections are used in all areas of machine construction. For example, the wheels or rims of a motor vehicle are generally fixed on a wheel carrier by means of several wheel nuts or wheel bolts. Central locking systems having only one central nut for motor vehicle wheels are also known, said systems being primarily used in sports cars and in motorsport. With screw or bolt connections that are used in particular in the context of rotating components, it is problematic that the threaded locking, in particular with longer operating durations, can be detached. For example, in the context of motor vehicle wheels, this presents a significant safety risk.

In view of this problem, so-called necked-down bolts are used, for example, in motor vehicle construction. After assembling, a so-called settlement in the screw connection takes place here by a plastic shaping of the necked-down bolt such that such a screwing is generally used without an additional rotation lock. After disassembling such a screw connection, a necked-down bolt is generally not able to be used again.

The German patent application DE 42 05 579 A1 describes a holding bolt for securing a central locking. Here, the wheel disc of a motor vehicle wheel having a central nut as a central locking element is threaded on a hub adaptor. A central shaft of the hub adaptor is provided with an inner thread into which the holding bolt can be screwed in order to thus secure the central nut.

A wheel central locking emerges from the German published patent application DE 10 2011 051 980 A1, wherein the wheel is fixed on a hub by a central nut being screwed onto an outer thread of the hub. Here, a securing element is also provided that is screwed into an inner thread of the hub and the head region of which covers the central nut such that this securing element can also serve as an anti-theft device.

The German published patent application DE 10 2011 115 534 A1 concerns a fixing system for the wheel hub of a motor vehicle. The wheel hub has a base body and an attachment, wherein the attachment has an outer thread for a nut.

A unitary wheel system for road vehicles emerges from the German utility model document DE 93 13 244 U1. Here, a wheel rim is provided with a hub adaptor that is able to be applied on the vehicle axle hub or the brake disc or drum by means of a bolting and a centring element. The hub adaptor has a cylindrical part that extends through the wheel rim and has a thread onto which a central locking nut is able to be threaded to fix the wheel rim on the hub adaptor.

The subject matter of the German published patent application DE 101 06 140 A1 is an assembling tool for central locking systems to fix wheels on a motor vehicle. The central locking system here comprises a kingpin provided with an outer thread on a part of its length and a wheel nut that is able to be threaded onto this. A bolt lock is allocated to the wheel nut, said bolt lock having a locking mechanism that is able to be disengaged against a spring load.

The German published patent application DE 10 2013 002 443 A1 describes a central locking element for fixing a component on a carrier. The central locking element is able to be threaded onto the carrier, wherein the central locking element has positive-locking means for engaging a tool for activating the central locking element.

Despite these approaches for forming securing elements, long-term and reliable securing of screw or bolt connections has only been solved inadequately. Thus, the object of the present invention is to provide an improved securing element and an improved securing system for securing screw or bolt connections.

### DISCLOSURE OF THE INVENTION

### Advantages of the Invention

This object is solved by a securing element and a securing system as arises from the independent claims. Preferred embodiments of this securing element and securing system are the subject matter of the dependent claims.

The securing element according to the invention is characterised in that the securing element is ring-shaped. The securing element has an outer profile along the outer circumference and an inner profile along the inner circumference. Both the outer profile and the inner profile are each formed from a plurality of profile units (PFE). According to the invention, the number of profile units of the outer profile and the number of profile units of the inner profile correspond to the number of graduation marks with different scales according to the Vernier principle, wherein the number of profile units of the outer profile and the number of profile units of the inner profile differ from each other by at least 1. The Vernier principle is thus implemented in such a way that the different numbers of profile units are each distributed evenly on the circumference. Thus, exactly one profile unit of the outer profile and exactly one profile unit of the inner profile are precisely opposite each other in precisely one position on the circumference of the securing element.

The securing element according to the invention can be used, in particular, in connection with a securing system that, apart from the securing element, comprises a first component or a first component arrangement having a first thread, in particular an outer thread, and a second component or a second component arrangement having a second thread, in particular an inner thread. The screw connection between the first thread and the second thread is secured by means of the securing element according to the invention. For this purpose, the first component or the first component arrangement has a region with a profile along the outer circumference and the second component or the second component arrangement has a region with a profile along the inner circumference, wherein, in the screwed-together state, a ring-shaped securing gap is formed between the profile of the first component or the first component arrangement and the profile of the second component or the second component arrangement, said securing gap being accessible from the outside. For this purpose, the outer circumference of the first component or the first component arrangement in the region with the profile along the outer circumference is expediently chosen to be smaller than the outer circumference of the region with the first thread, in particular, the outer thread. The securing element according to the invention is provided for arrangement (insertion) inside the ring-shaped securing gap between the first and the second component (or component arrangement). The securing element according to the invention, however, can be used not only for securing a screw connection between two components (or component arrangements), but also for other ways of connecting two components, for example for securing a plug connection.

The term “component arrangement” can be understood to mean that the corresponding component can be constructed to be in several parts. If the first component or the second component is referred to in the following, this can be understood to also mean the first component arrangement or the second component arrangement respectively.

The profiles are expediently formed in such a way that the profile along the outer circumference of the first component has a number of profile units (PFE) that corresponds to the number of PFE of the inner profile of the securing ring in a complementary manner. The profile along the inner circumference of the second component expediently has a number of PFE that corresponds to the number of PFE of the outer profile of the securing element in a complementary manner. Consequently, the number of PFE of the outer profile of the first component and the number of PFE of the inner profile of the second component are different, wherein the numbers differ by at least 1 and preferably by precisely 1. Depending on the positioning of the second component in relation to the first component, in the screwed state, the geometry or the specific shape of the securing gap formed between these profiles is formed to be different. That is to say, the position of the outer profile relative to the inner profile, depending on how much or less the bolt thread is tightened, is different and is not fixedly predetermined. The geometry of the securing gap formed between the profiles is variable to some extent and is generally not able to be predicted. For assembling the securing element, the securing element is introduced into the securing gap, wherein the securing element is inserted, rotated and re-inserted until it locks exactly into place. This rotation until it is locked exactly in place is required since, because of the geometry of the formed securing gap that is not able to be predicted in detail, the securing element in fact locks exactly into place in one position in the securing gap. When the securing element is locked exactly into place in the securing gap, the screw connection (or, where appropriate, a different connection) between the first and the second component is locked, such that it there can be no resulting loosening of the connection that could be caused by vibrations.

The surprising effect of the securing element according to the invention when the connection between the two components locks can be explained by the Vernier principle. The best-known use of the Vernier principle is a calliper wherein two measuring scales having a different measure or having different length units are laid one on top of the other. In the corresponding choice of scales, a length that is to be measured can be very precisely determined, wherein, for a fine determination, the coming together of two graduation marks of the different scales is observed. In a corresponding manner, the external and internal sides of the securing gap of the securing element according to the invention are formed with a different number of PFE. The numbers of PFE thus correspond to the different scales or length units according to the Vernier principle. Individual PFE of the securing gap are precisely opposite one another only in one certain position within the securing gap. This position is responsible for the exact locking into place of the security element.

The Vernier principle and its use for the present invention are explained in more detail below. In the known use of the Vernier principle for the calliper, a fixed main scale (the so-called limbus) and a sub-scale (the so-called Vernier) to be moved are provided for reading decimal places. Line lengths which are smaller than the finest division of the main scale can be read by means of the sub-scale. The length units of the Vernier are shortened compared to the length units of the limbus. Measuring by means of such a calliper thus makes use of the fact that there is exactly one graduation mark on the Vernier which is exactly opposite a graduation mark on the limbus, i.e. the main scale. A further use of the Vernier principle is the so-called Vernier connector. Here it is a part from assembly technology wherein two rods with different numbers of perforations are provided. The perforations thus correspond to the different scales according to the Vernier principle, wherein, depending on the alignment of the rods relative to each another, certain perforations are one on top of the other and can be connected to one another by means of bolts or similar.

In the present invention, the different scales are used according to the Vernier principle for the ring-shaped securing element, wherein the different scales are arranged as profiles on two different, concentric circumferences with different diameters. In doing so, a plurality of profile units, e.g. waves, are evenly distributed on the circumference (360°) of the securing element for the first profile (outer) and the second profile (inner), wherein the number of profile units of the first profile along the circumference (outer profile) and the number of profile units of the second profile along the circumference (inner profile) differ by at least 1 and preferably by precisely 1. If, for example, 18 waves for the outer profile are distributed on the circumference (spacing in each case of 20.00°), 17 waves for the inner profile are distributed on the circumference (spacing 21.18°). Considering these waves are numbered consecutively, the waves would, for example, be exactly opposite one another in the first position. All remaining waves are more or less displaced against one another. The outer profile in this example would be labelled as Vernier (smaller distance between the waves) and the inner profile as limbus (larger distance between the waves). The components that are to be locked to one another in their connection (e.g. screw connection) by this securing element each have a mirror-inverted corresponding profile. If, for example, a clamping nut were to be fixed on a bolt (e.g. wheel hub) or similar, the clamping nut would have a profile along the inner circumference having 18 mirror-inverted waves that correspond to the Vernier of the securing element. The wheel hub would have a profile along the outer circumference having 17 waves that correspond to the limbus of the securing element in a mirror-inverted manner. When the clamping nut is now screwed onto the wheel hub e.g. by a torque handle, the 18 waves of the profile along the inner circumference of the clamping nut and the 17 waves of the profile along the outer circumference of the wheel hub come “to a stop” in a position that cannot be predicted because of the torque, wherein in principle one wave pair or one pair of profile units are always (coincidentally) precisely opposite each other on a point that cannot be predicted, comparable to the calliper mentioned above. Since also with the securing element, according to the invention, precisely one pair of profile units are opposite each other, the securing element can be correspondingly inserted in this position and then locks in, whereby the connection of the two components is secured and can no longer be moved. The suitable position of the securing element is, in practice, found by the securing element being attached, rotated and attached again until it fits. In practice, it has become apparent that there is in fact always one position in which the securing element can be inserted and locked-in. This surprising effect of the securing element according to the invention is thus based on the Vernier principle and is implemented by the number of profiles differing by at least 1 inside and outside, wherein a profile unit inside and a profile unit outside are exactly opposite each other. The system is not limited with regards to delicate adjustment possibilities and, in practice, is able to be continuously adjusted. By increasing the number of profiles, the delicate adjustment possibilities can, in principle, be operated to infinity, wherein here, generally, practical limits, above all with regards to the finishing possibilities, are set. In practice, using 18 and 17 profile units, for example, has proved to be effective, which, with regards to the delicate adjustment possibilities, is completely sufficient. The system is also completely independent of a thread pitch, since the congruence (coincidence) of the profile units can take place in any position on the circumference.

Furthermore, the system is also not limited to screw connections. It can also be used for other types of connections of two components. For example, the securing element according to the invention can also be used for plug connections, if the corresponding components to be connected are fitted with the profiles described above.

In other words, the invention is effectively a concentric use of the Vernier principle by which two components can, in principle, be locked to each other in any position by means of a securing element (locking element). The Vernier principle is thus implemented by the concentric outer and inner profile of the securing element that differ by at least one profile unit. In conjunction with the corresponding (mirror-inverted) profile of the components to be locked, whose shaping define a securing gap into which the securing element is inserted, the advantages of the Vernier principle are shown by this application. The securing gap is formed between the components to be locked, wherein the profiles of the securing gap correspond to the profiles of the securing element in a mirror-inverted manner. The Vernier principle thus ensures that the securing element can be locked in on one particular point with an accurate fit and thus securely prevents a relative movement of the components to each other and locks the connection of the components. The Vernier principle thus manifests itself as a physical feature of the securing element, since the outer profile corresponds to the Vernier (smaller distance between the individual profile units) and the internal profile corresponds to the limbus (larger distance between the profile units) or, where appropriate, also vice versa in a concentric manner. According to the Vernier principle, precisely one profile unit pair is thus always opposite each other, as emerges from view of a calliper. According to the invention, the outer and inner profile of the securing element correspond to the securing gap that is formed by the components to be locked. Because of this mirror-inverted correspondence, it is possible that, in any position of the components relative to each other, a securing gap is formed into which the securing element can lock. In principle, the specific geometry of the securing gap always looks different, regardless of the position of the components relative to each other, since the outer and the inner profile of the securing element “come to a stop” in different positions relative to each other, regardless of the position of the components. All possible geometries of the securing gap are thus depicted by the securing element that can then be inserted in a corresponding position. The Vernier principle enables one position to always arise in which the securing element can lock.

The outer profile of the securing element runs along the outer side, i.e. on an outer casing surface, of the securing element. The inner profile along the inner circumference runs along the inner side, i.e. on an inner casing surface, of the securing element. Here it is preferred that the outer profile and/or the inner profile only cover a partial region of the outer and/or inner casing surface of the ring-shaped securing element. In particular, it can be provided that only one lower terminal region of the ring-shaped securing element is covered by the outer profile and the inner profile. The securing element effectively has one collar that is provided with the outer profile and the inner profile according to the invention. The other terminal region of the ring-shaped securing element can have a casing surface along the outer circumference that has a larger circumference, said casing surface not being provided with the profile according to the invention. This region can, for example, be formed to be flat or with small ribbings or knurlings. Ribbings, knurlings or similar have the advantage that a securing element fitted in this way can be held more easily and operated more easily for manual assembly or for assembly with a handling device.

Expediently, one or more means for securing the securing element in the assembled state are provided; for example, the first component can be provided with an (additional) inner thread such that, after assembling the securing element, the securing element itself can be secured by a further securing bolt or screw. In a different embodiment, the first component can be provided, for example, with a peripheral recess that, in the assembled state of the securing system, is adjacent to the assembled securing element such that the securing element can be axially secured in position and fixed by a common groove ring or securing ring. Other possibilities for securing the securing element are, for example, pins or splints that can be used depending on the application.

Depending on the type and construction of the components whose connection is to be secured relative to one another, the securing element according to the invention and the securing system can be formed differently. For example, an internal component can be secured, e.g. when a rotating component is to be secured on a shaft or an adaptor. In a different case, an external component can be secured. Furthermore, it is generally possible to secure a bolt or screw with the securing system according to the invention. In each case, the number of PFE between the outer profile of the securing element differs from the number of PFE of the inner profile. Here it is possible that either the number of PFE of the outer profile or the number of PFE of the inner profile is higher.

In a particularly preferred embodiment of the securing element, the PFE of the outer profile and/or the inner profile of the securing element are formed to be wave-shaped or approximately wave-shaped. A wave shape of the PFE has particular advantages with regards to the finishing process of the securing element according to the invention. The PFE can, however, in principle also have any other geometry, for example the profiles can be implemented to be rhombus-shaped, or wedge-shaped or serrated or as mixed shapes. Furthermore, it is not necessary for the PFE of the outer profile and the inner profile to be formed to be the same. It is definitely possible that the shape of the outer profile and that of the inner profile, independent of the number of PFE, can also be different in shape. The shape of the PFE can be adjusted, in particular in adjusting to the finishing possibilities of the securing element and also of the remaining components of the securing system. In particular, the possibilities for a finishing also depends on the dimensions of the securing system.

The number of PFE of the outer profile and the inner profile of the securing element, according to the invention, differs by at least 1. For example, the lower number of profile units can be at least 9 and the higher number of profile units can be at least 10, for example precisely 9 and 10. In a different example, the lower number of profile units can be 15, for example, and the higher number of the profile units can be 18. Other numbers and differences of profile units are also possible. In practice, a difference of precisely 1 has proved to be advantageous. In a particularly preferred exemplary embodiment, the numbers of PFE are 17 and 18, e.g. 18 PFE with the outer profile and 17 PFE with the inner profile of the securing element.

The number of profile units and the shape, as already mentioned above, can be adjusted depending on the respective application and depending on the dimensions of the securing system and the finishing possibilities connected thereto. The profile structures of the securing system according to the invention can, for example, be produced by milling technology or by plastic moulding, for example injection moulding, metal moulding, 3D printing, forging, punching, pressing, lasering, grinding or broaching.

For a simple assembly of the securing element according to the invention, it is advantageous if the outer profile and the inner profile of the securing element, in conjunction with the profile along the outer circumference and the profile along the inner circumference of the first and second component enable a slight clearance when inserting the securing element into the securing gap formed between the first and second component. The components should also be formed in such a way that no highly precise bearing seat is implemented, but rather the parts reach into one another such that they slide slightly. The finishing tolerances are preferably chosen in such a way that a clearance fit (shaft−, bore+) is achieved, comparable to the clearance fit with the elements of a telescopic tube.

In a further embodiment of the securing element according to the invention, the outer profile and the inner profile of the securing element are located on two different levels of the securing element. The outer profile and the inner profile are therefore a first profile and a second profile that in each case run around different circumferences on different levels of the securing element, wherein one circumference runs outside and the other circumference runs further inside. The securing element can thus, in principle, be formed in a certain manner as a round disc with the peripheral profiles arranged to be ring-shaped on the steps such that this embodiment is also ring-shaped. In this embodiment, the first profile and the second profile are also each formed from a plurality of profile units, wherein the number of profile units of the first profile and the number of profile units of the second profile correspond to the graduation marks with different scales according to the Vernier principle and wherein the number of profile units of the first profile and the number of profile units of the second profile differ by at least 1 and wherein a profile unit of the first profile and a profile unit of the second profile are exactly opposite each other in exactly one position.

The invention further comprises a securing system for connecting a first component or a first component arrangement and a second component or a second component arrangement, wherein the first component or the first component arrangement has a region having a profile along the outer circumference, and wherein the second component or the second component arrangement has a region having a profile along the inner circumference. In the connected state of the components, a ring-shaped securing gap is formed between the profile of the first component or the first component arrangement and the profile of the second component or the second component arrangement, the described securing element being able to be inserted into said securing gap as a component of the securing system. The ring-shaped securing gap can also be formed in such a way that the profile along the outer circumference and along the inner circumference of the components in the assembled state of the components are arranged to be stepped, such that a securing element can be inserted whose profiles are arranged on two levels.

The connection of the two components or the component arrangements of the securing system according to the invention is preferably a screw connection, wherein here the first component (or component arrangement) is provided with a first thread, in particular an outer thread, and the second component (or component arrangement) is provided with a second thread, in particular an inner thread. The second component and the first component are able to be screwed together by means of these threads. The first component has a region having a peripheral profile on the outer side, i.e. outside. The second component has a region having a peripheral profile on the inner side, i.e. inside. In the screwed-together state, a ring-shaped securing gap is formed between the profile of the first component and the profile of the second component, said securing gap expediently being accessible from the outside. Furthermore, the securing system comprises the described securing element, wherein the securing element is ring-shaped and has an outer profile along the outer circumference and an inner profile along the inner circumference. Both the outer profile and the inner profile are in each case formed from a plurality of profile units (PFE), wherein the number of PFE differs by at least 1 and exactly one profile unit inside and exactly one profile unit outside are exactly opposite each other. This securing element is provided for arrangement in the securing gap in the manner described above.

Expediently, the number of PFE of the outer profile along the outer circumference of the first component corresponds exactly to the number of PFE of the inner profile of the securing element, wherein the profile along the outer circumference of the first component (or the first component arrangement) is mirror-inverted relative to the inner profile of the securing element. Furthermore, the number of PFE of the inner profile along the inner circumference of the second component corresponds exactly to the number of PFE of the outer profile of the security element, wherein the profile along the inner circumference of the second component (or the second component arrangement) is mirror-inverted relative to the outer profile of the securing element. The inner profile of the securing element is thus complementary to the profile along the outer circumference of the first component. The outer profile of the securing element is complementary to the profile along the inner circumference of the second component. The first component can, for example, generally be a mount, e.g. a shaft, a shaft end, a hub or an adaptor, for example a hub adaptor. The second component can be a nut, for example a clamping nut or a union nut.

In a particularly preferred embodiment of the securing system according to the invention, the securing system further comprises at least one means for securing the securing element in the assembled state. With regards to further details about this means and also with regards to further details about the remaining features of the securing system, reference is made to the description above.

Furthermore, the invention comprises the use of the securing system according to the invention for securing a screw connection that is provided, for example, for fixing a component provided for a rotating movement. In particular with rotating components, over time it can result in a detachment of screw connections because of the herewith connected movements. This is avoided with the securing system according to the invention. A particularly preferred example for the use of the securing system according to the invention is the securing of a central lock for a wheel in a vehicle, in particular in a motor vehicle, in particular in conjunction with a wheel hub or a wheel hub adaptor. Such a central lock is exposed to particular rotating loads such that the securing element according to the invention can be used here to great advantage. The securing system according to the invention can also be advantageously used for the common fixing of motor vehicle wheels with wheel nuts or wheel bolts. Furthermore, the securing system according to the invention can also generally be used for securing a bolt. In using the securing system according to the invention for a bolt, the formation of the bolt as a necked-down bolt, for example, can be avoided. This has the advantage that such a bolt can, in principle, often be used again, in contrast to a necked-down bolt. The securing system according to the invention can, however, also be used as an additional securing with a necked-down bolt. Furthermore, the securing system according to the invention is, in principle, suitable for securing all kinds of screw connections. It can be used in the different fields of machine construction. Examples of this are generally drive shafts and gear shafts, for example in the context of vehicle construction, aeroplane construction or with wind power plants, marine propellers or ventilators. Generally, the securing system according to the invention or the securing element according to the invention are suitable for mechanically securing all screw connections that are established as components of a corresponding securing system. In particular, the securing system according to the invention is suitable for mechanically securing screw connections in which the assembled position of the components connected via the screw connection is not set in a predictable manner, but rather in which the position of the components relative to one another in the assembled state is dependent, for example, on the torque when tightening the screw connection.

Finally, the invention comprises a wheel hub or a wheel hub adaptor or a clamping nut or a bolt, for example an necked-down bolt, that are configured to be used in the securing system according to the invention. Said components are fitted with a profile along the outer circumference or along the inner circumference and with a thread according to the principle according to the invention. According to the definitions introduced above, a wheel hub or a wheel hub adaptor or a bolt correspond in each case to the first component of a securing system according to the invention. A clamping nut corresponds to the second component of a securing system according to the invention. In a further embodiment of a wheel hub, the wheel hub can also correspond to the second component or the second component arrangement, wherein the second component arrangement can be composed of a flange (wheel disc) and a shaft.

Further features and advantages of the invention arise from the description below of exemplary embodiments in combination with the drawings. Here, the individual features can be each be implemented individually or in combination with one another.

### BRIEF DESCRIPTION OF THE DRAWINGS

In the figures are shown:

FIG. 1A, B isometric explosive depictions of the elements of the securing system according to the invention in a first embodiment from two perspectives (partial figures A and B);

FIG. 2A, B-FIG. 5A, B isometric depictions of the elements of the securing system according to the invention in a further embodiment, each from two perspectives (partial figures A and B);

FIG. 6 sectional depiction of the securing system from FIG. 5;

FIG. 7A, B-FIG. 10A, B isometric depictions of the elements of the securing system according to the invention in a further embodiment, each from two perspectives (partial figures A and B);

FIG. 11 schematic depiction of different embodiments of the profile structures of the securing system according to the invention;

FIG. 12 further examples of possible profile structures;

FIG. 13 isometric depiction of a wheel hub adaptor according to the invention;

FIG. 14 isometric depiction of a wheel hub according to the invention;

FIG. 15 isometric explosive depiction of the elements of the securing system according to the invention for securing a central lock in a motor vehicle wheel;

FIG. 16 isometric explosive depiction of the elements of the securing system according to the invention for securing a bolt;

FIG. 17A, B plan view of the securing system from FIG. 16 without securing element (partial Figure A) and with securing element and additional groove ring (partial Figure B);

FIG. 18 sectional depictions of the securing system of FIG. 16;

FIG. 19 isometric explosive depiction of the elements of the securing system according to the invention for securing a further embodiment of a central lock in a motor vehicle wheel; and

FIG. 20 sectional depiction of the securing system of FIG. 19.

### DESCRIPTION OF EXEMPLARY EMBODIMENTS

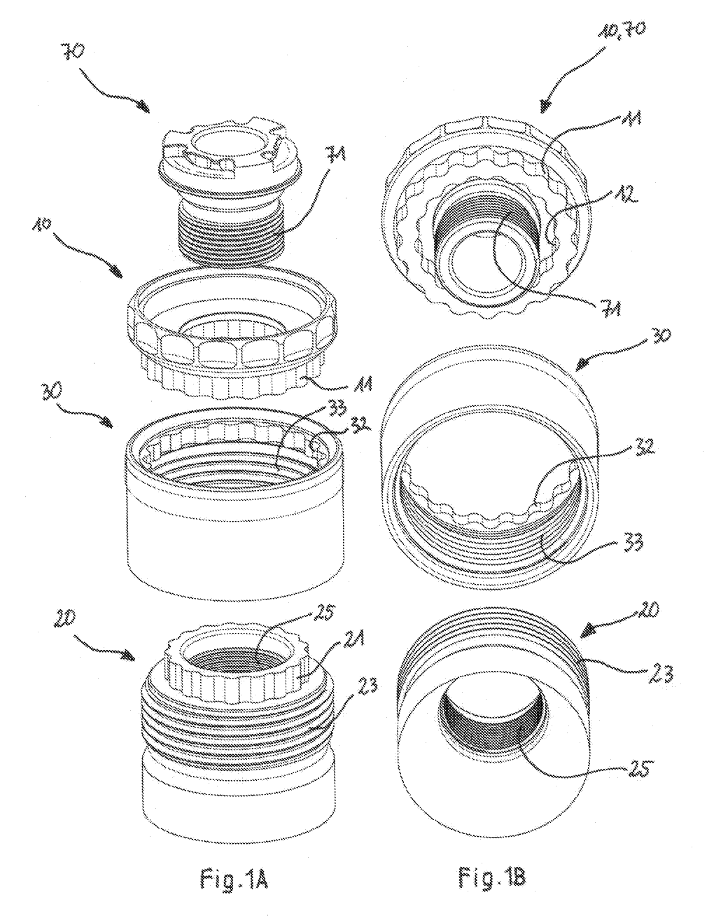

FIG. 1A, B illustrate the different elements of the securing system according to the invention from two perspectives (partial FIGS. 1A and 1B) in explosive depictions. This example of the securing system comprises a first component 20, for example a shaft end, a second component 30, for example a union nut, and a ring-shaped securing element 10. Furthermore, a fixing bolt 70 is provided. The first component 20 is provided with an outer thread 23 in a central region. The second component 30 has a corresponding inner thread 33 such that the second component 30, for example the union nut, can be threaded onto the first component 20. A rotating component (not shown), for example, that is to be fixed on the first component 20, can be fixed by this screw connection. The components 20, 30 comprise structures that allow a locking of the screw connection by means of the ring-shaped securing element 10 for securing this screw connection. These structures are, in terms of the first component 20, a profile 21 that, in this example, is arranged in a terminal region and runs around on the outer side. In terms of the second component 30, these structures are a profile 32 that runs along the inner side and that, in this example, is arranged in a terminal region. The region with the profile running along the outer side 21 of the first component 20 is smaller in circumference that the region having the outer thread 23. When the second component 30 is threaded onto the first component 20, a securing gap is formed between the profile along the inner circumference 32 of the second component 30 and the profile along the outer circumference 21 of the first component 20, the securing element 10 being inserted into said securing gap. The securing element 10 thus effectively has a collar with complementary structures, i.e. with an outer profile 11 along the outer circumference and an inner profile 12 along the inner circumference on the inside of the ring-shaped securing element. In this depiction, these structures are on a lower terminal region of the securing element 10. The number of profile units (PFE) of the outer profile 11 corresponds to the number of PFE of the profile along the inner circumference 32 of the second component 30 and the number of PFE of the inner profile 12 of the securing element 10 corresponds to the number of PFE of the profile along the outer circumference 21 of the first component 20. It is essential for the function of the securing element 10 or the securing system according to the invention that the number of PFE of the outer profile 11 and the inner profile 12 of the securing element 10 differ by at least 1, wherein the numbers of the profiles of the first component 20 and the second component 30 are corresponding. When assembling the securing element, the securing element 10 is inserted, rotated and re-inserted in the securing gap (ring gap) formed between the first component 20 and the second component 30 until it locks exactly into place, such that the screw connection between the first component 20 and the second component 30 is locked. A fixing bolt 70 is provided with a threaded bolt 71 to fix the securing element 10 in position. The fixing bolt 70 is subsequently inserted into an inner thread 25 of the first component 20.

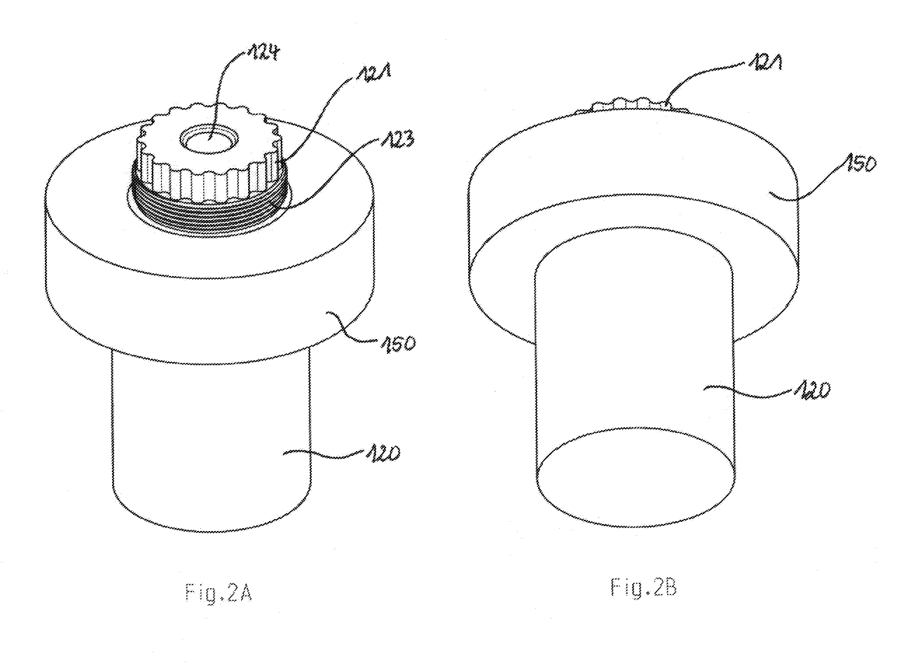

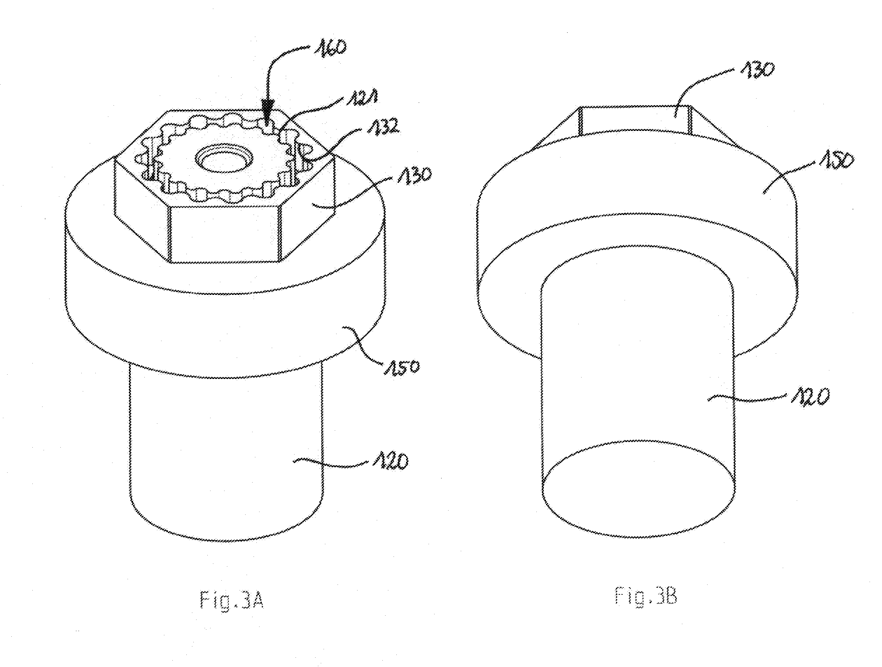

FIG. 2A, B-5A, B illustrate one embodiment of the securing system according to the invention for securing a screw connection on the end of a shaft, i.e. on a shaft end, in each case from two isometric perspectives (partial Figures A and B). FIG. 2 here firstly shows the first component 120 on which a further component 150 is fixed. The further component 150 can for example be a component provided for a rotating movement, for example a wheel or similar, that is to be fixed on the first component 120 shaped as a shaft end. The further component 150 is placed on the first component 120 and is fixed with a nut (second component 130), wherein this fixing is secured by means of the securing system according to the invention. Comparable to the component 20 from FIG. 1, an outer thread 123 and subsequently a wave-shaped profile 121 along the outer circumference is provided in a terminal section of the first component 120. A blind hole recess 124 is provided with an inner thread that serves the further securing of the securing element that will be explained in more detail later on the front side of this terminal section of the first component 120. In addition to the first component 120, FIG. 3 shows a second component 130 in the shape of a clamping nut. The component 130 (clamping nut) is threaded onto the outer thread 123 of the first component 120 via an inner thread that is not visible here. The second component 130 has a profile 132 along the inner circumference on the inside in a terminal region. The profile 132 along the inner circumference of the second component 130, in the assembled state, forms a securing gap 160 together with the profile 121 along the outer circumference of the first component 120. The geometry or shape of this securing gap 160 in terms of the specific positions of the individual PFE of the profiles relative to one another is not predictable since they depend on the specific position of the second component 130 on the first component 120. FIG. 4 illustrates how the securing element 110 that, in this depiction, has an outer profile 111 along the outer circumference and an internal profile 112 along the inner circumference in a lower section (collar), is to be inserted into the securing gap 160. To do so, the securing element 110 is inserted into the securing gap 160, rotated and then re-inserted until it locks exactly into place. As can be seen in this depiction, the number of PFE of the outer profile 111 differs from the number of PFE of the inner profile 112 of the securing element 110. In this example, there are 15 profile units in the outer profile 111 and 18 profile units in the inner profile 112. In a different, particularly preferred exemplary embodiment, 17 or 18 profile units, for example, can be provided inside or outside respectively. The number of PFE of the profile 132 along the inner circumference of the second component 130 and the number of PFE of the profile 121 along the outer circumference of the first component 120 are correspondingly adjusted. When the securing element 110 is locked exactly into place in the securing gap 160, the screw connection between the first component 120 and the second component 130 is locked and reliably secured. FIG. 5 shows the securing system 500 in the completely assembled state. Here, a securing bolt 170 is further shown that, in this embodiment, has a hexagonal socket, for example, for engaging an activation tool. This securing bolt 170 is rotated into the inner thread of the blind hole recess 124 of the first component 120 that is able to be seen in FIG. 2, such that the securing element 110 is also secured and fixed in position.

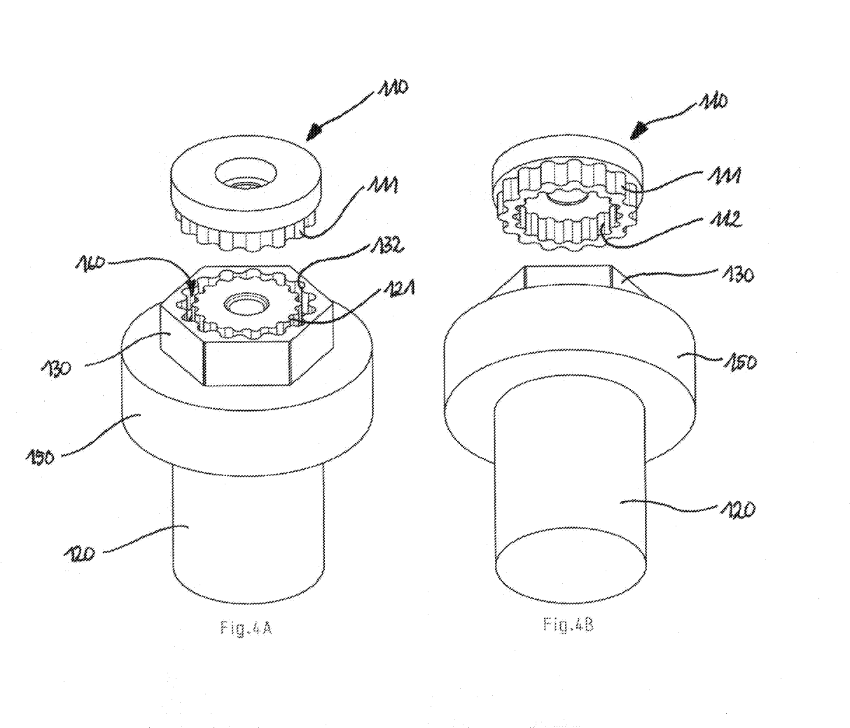

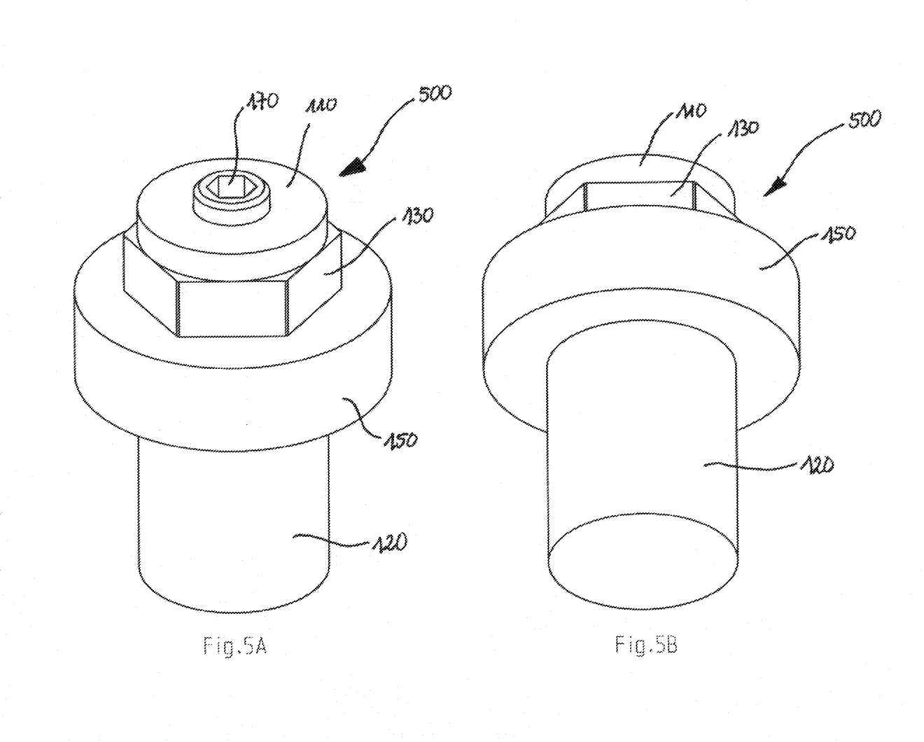

FIG. 6 shows a sectional depiction of the securing system 500 of FIG. 5 with corresponding labelling.

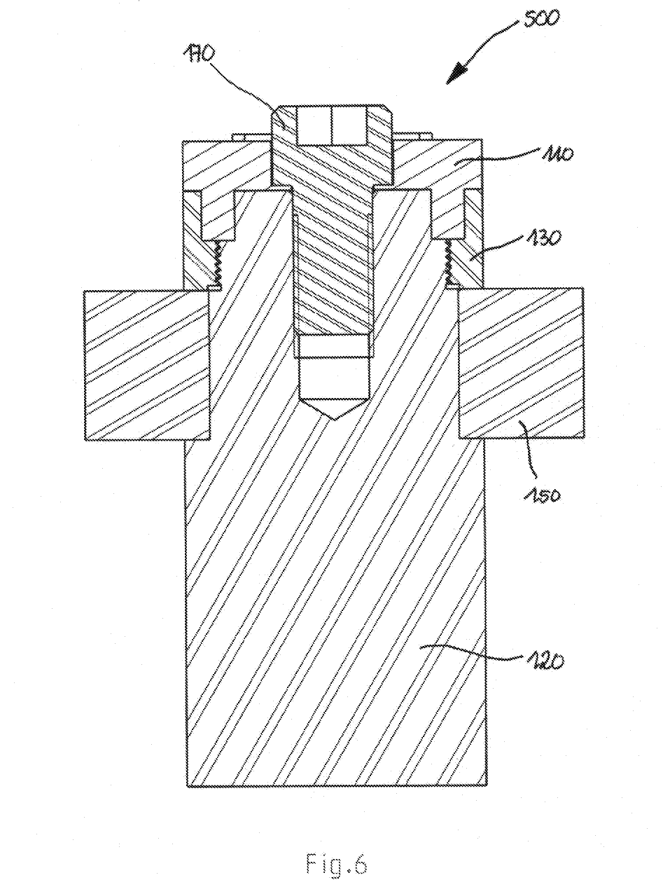

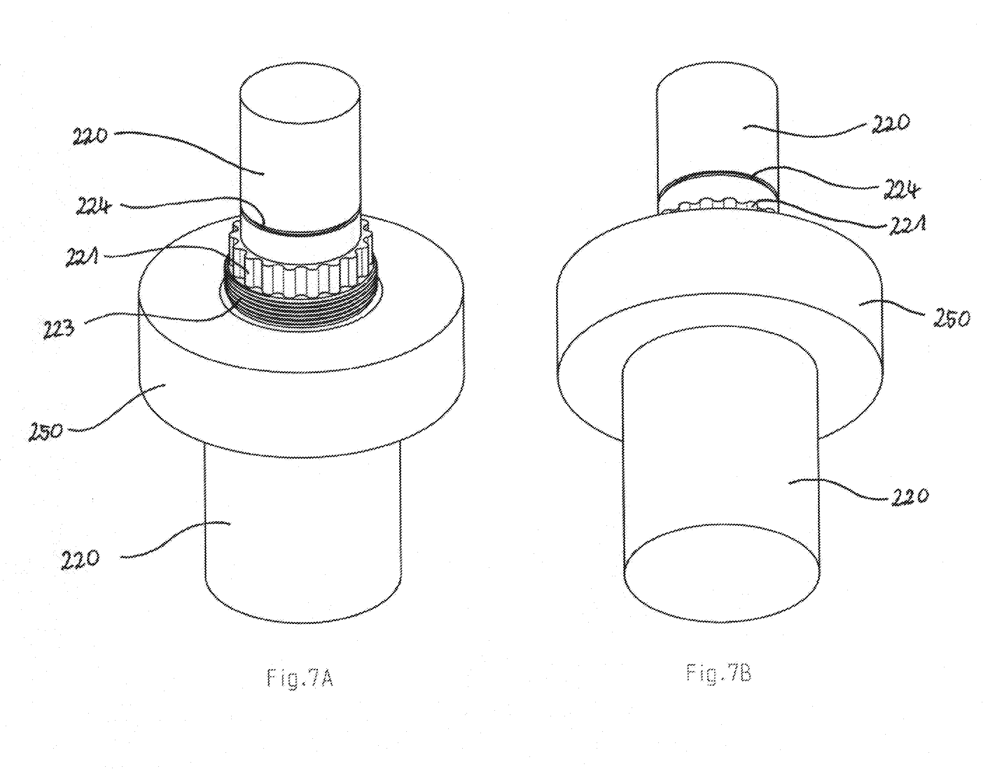

FIG. 7A, B-10A, B illustrate a further possible embodiment of the securing system according to the invention, in each case from two isometric perspectives (partial Figures A and B), wherein a further component 250 is fixed and secured on a continuous shaft. FIG. 7 shows the continuous shaft 220 as the first component. The further component 250, for example a wheel, is fixed on this shaft. Fixing this wheel takes place by means of a screw connection that is secured according to the invention. To do so, the shaft 220 has, in a region that is adjacent to the further component 250, an outer thread 223 and a subsequent region with a profile along the outer circumference 221. The region with the profile along the outer circumference is smaller in circumference than the region with the outer thread 123. A peripheral recess or a groove 224 that serves for the securing of the securing element according to the invention that will be explained in further detail below is at a distance relative to the outer profile 221 along the outer circumference. In addition to the first component 220 in the shape of the continuous shaft having the component 250 fixed thereon, FIG. 8 shows a second component 230 that is a component of the securing system. Comparable to the depiction in FIG. 3, the second component 230 is formed in the shape of a clamping nut that has a profile 232 along the inner circumference. The profile 232 forms a securing gap 260 together with the profile along the outer circumference 221 of the first component 220, the securing element 210 (FIG. 9) is to be inserted into said securing gap 260. Correspondingly, as described by means of FIG. 4, the securing element 210 is inserted into the securing gap 260 and is rotated until it locks exactly into place and thus locks the screw connection between the first component 220 and the second component 230. FIG. 10 shows the finished assembled state of the securing system 900. A groove ring 270 (snap ring) is provided for axially fixing the securing element 210 in place, said groove ring 270 engaging with the recess 224 of the first component 220 (FIG. 7).

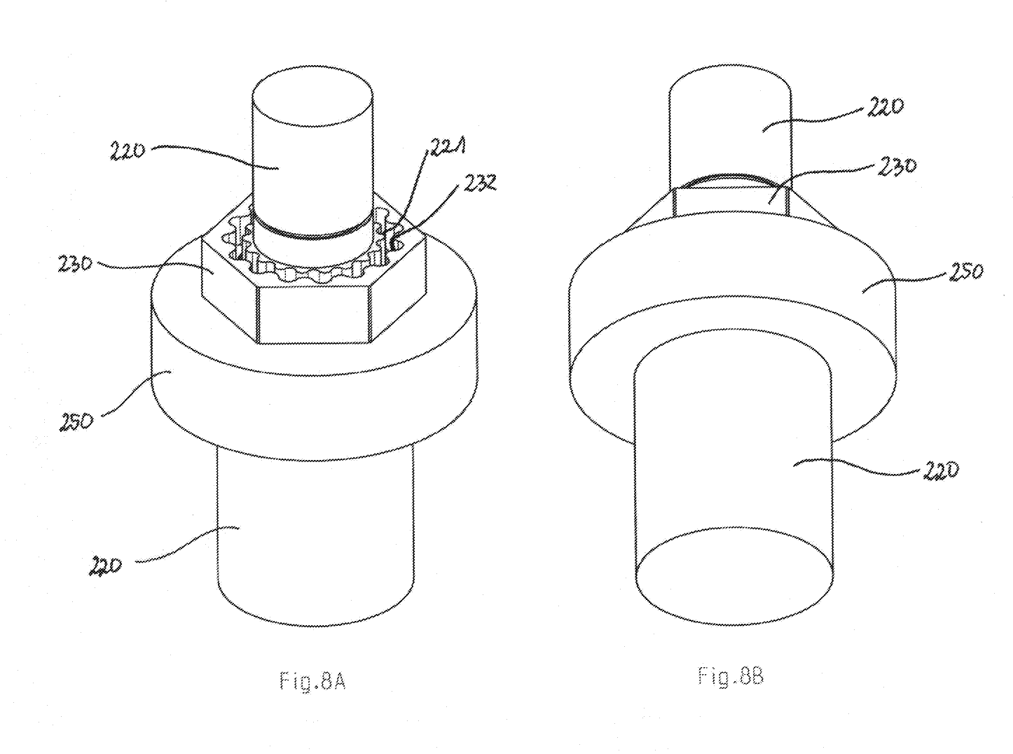

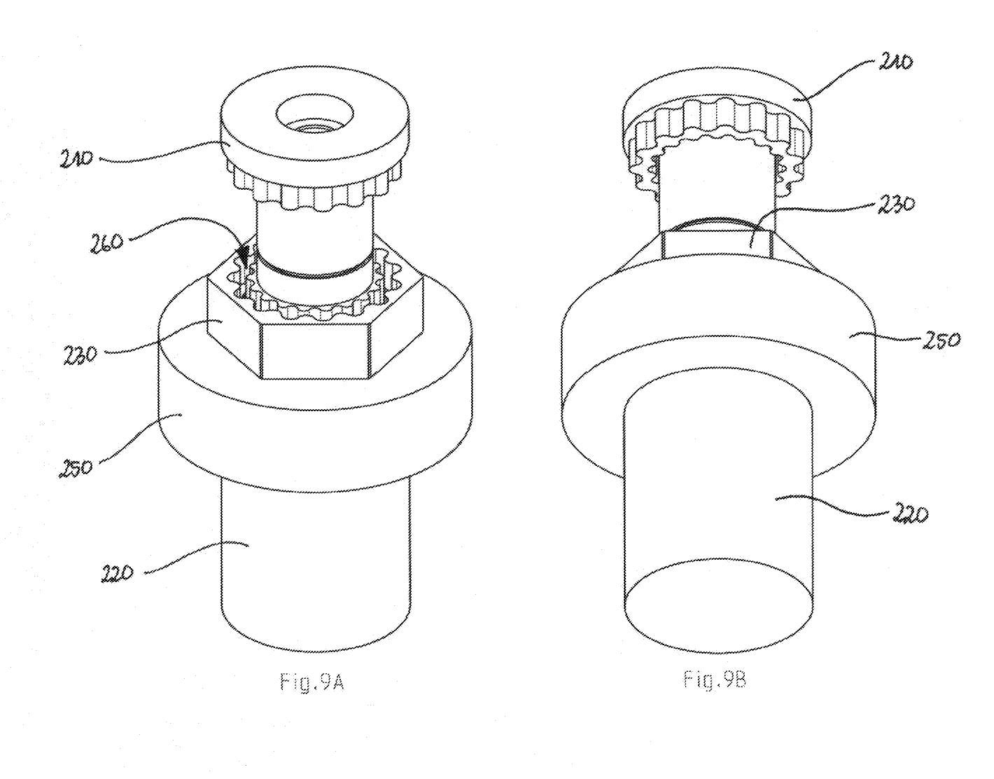

FIG. 11 illustrates, in a schematic manner, possibilities for the geometries of the profile structures of the securing system according to the invention. A plan view and a view sloped from above the profile structures are shown in each case. The example labelled with 410 shows wave-shaped structures, wherein both the profile along the outer circumference 411 of an internal component 412 and the profile along the inner circumference 413 of an external component 414 are formed to be wave-shaped having 9 or 10 profile units. A securing gap is formed between the profile 411 and the profile 413, a securing element according to the invention is to be inserted into said securing gap. The reference numeral 420 labels a further example of a possible geometry of the profile structures. The profile 421 along the outer circumference of the internal component 422 is formed to be approximately wave-shaped. The profile 423 along the inner circumference of an external component 424 is formed to be the shape of a rhombus. The example labelled with the reference numeral 430 shows a further possibility for the shaping of the profile structures. The examples 470, 480, 490, 510, 520, 530, 540, 550, 560, 570, 580, 590, 610, 620, 630 shown in FIG. 12 indicate further principle possibilities for the formation of the profiles, wherein the shapes shown can be used both for the inner profile and for the outer profile of the securing element and for the corresponding profiles of the first and the second component. The patterns shown are, in principle, able to be combined in any way with one another and other patterns are also possible.

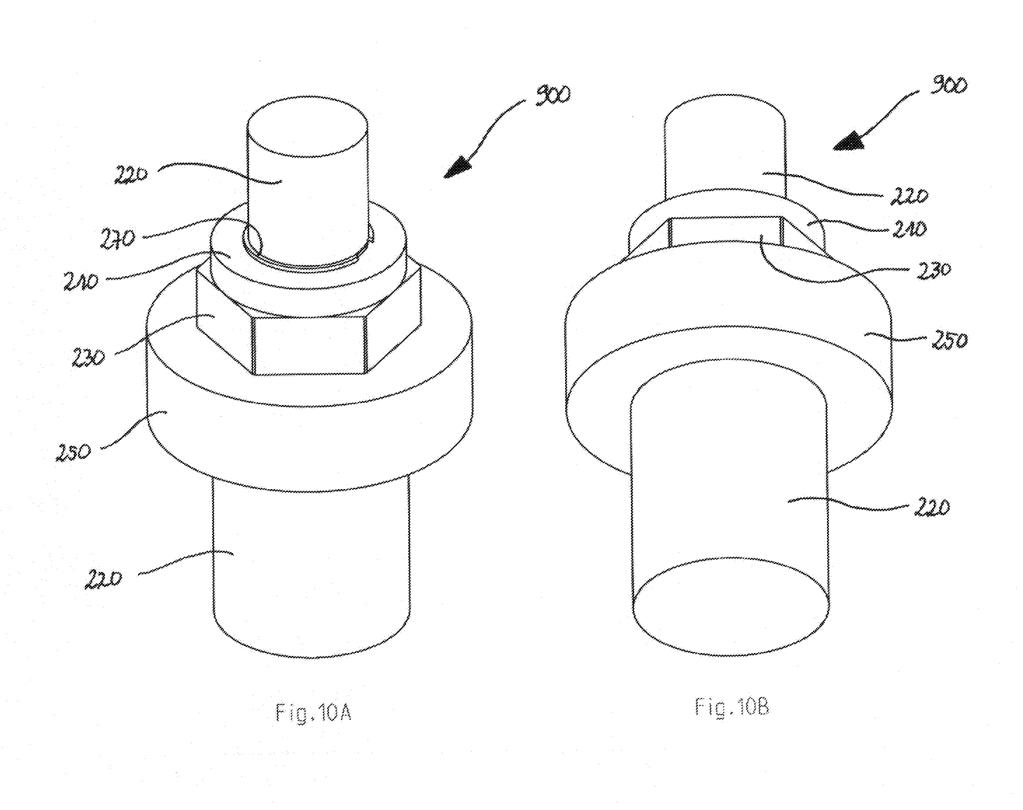

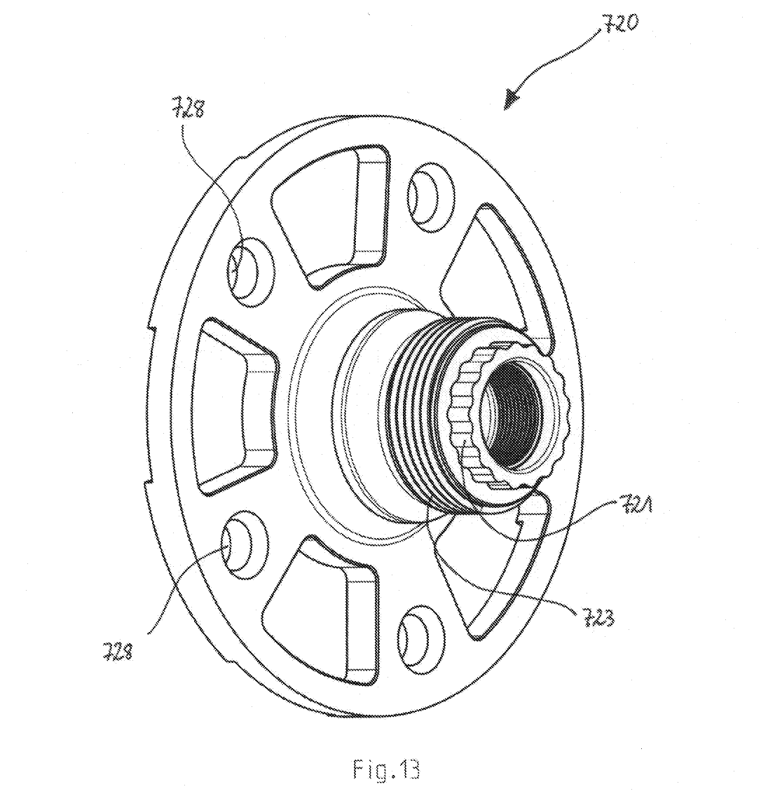

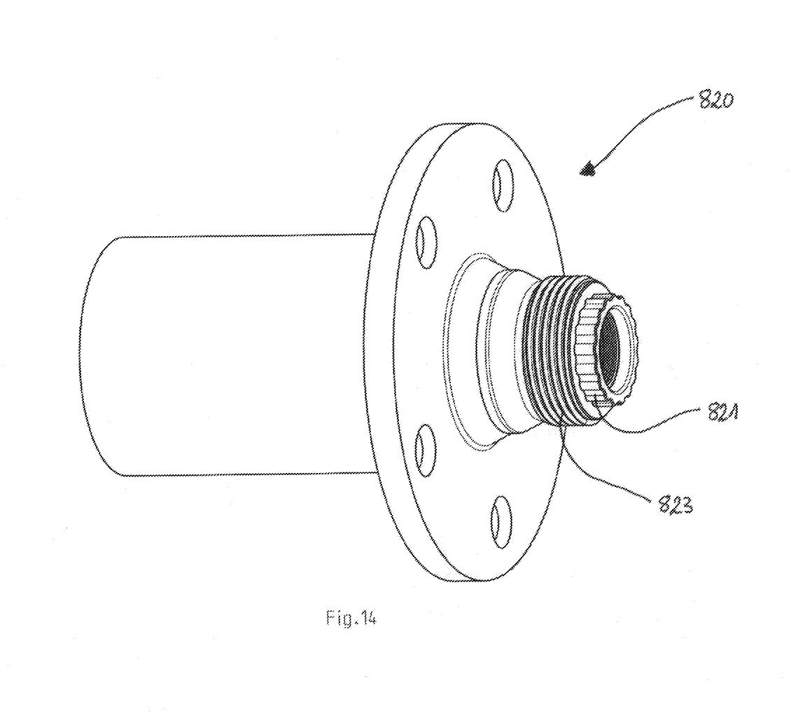

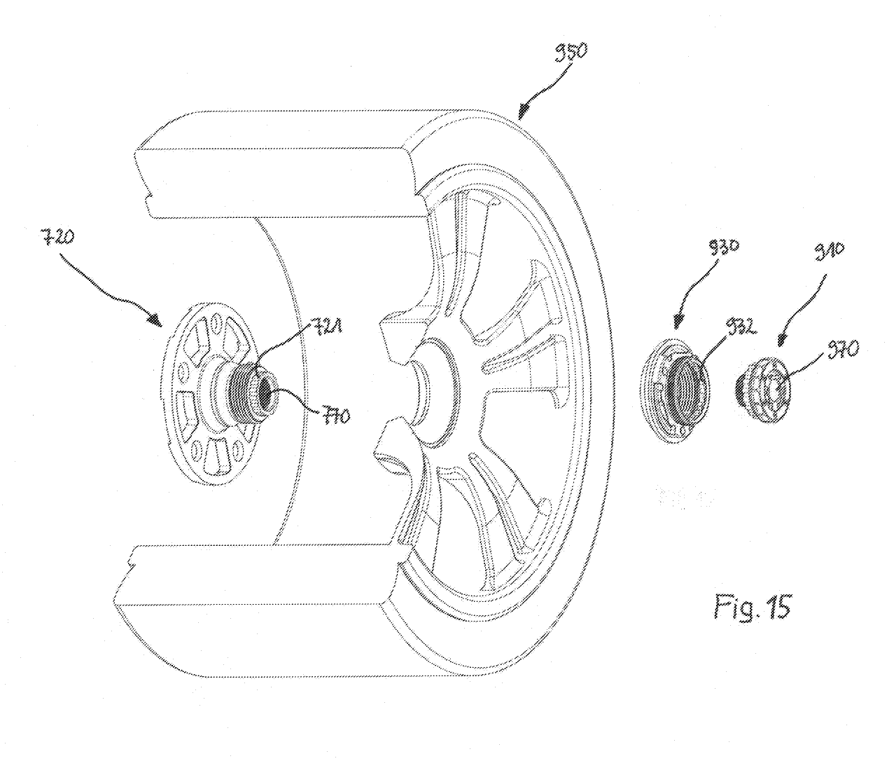

FIG. 13 shows a wheel hub adaptor 720 that is set up to be used in the securing system according to the invention. The wheel hub adaptor 720 can be used, for example, together with a standard wheel disc. The wheel hub adaptor 720 is provided with an outer thread 723 on a centrally protruding hollow cylinder-shaped extension. On the outer thread 723, a profile 721 along the outer circumference is connected on a terminal section of the extension. Furthermore, recesses (bores) 728 are provided by means of which fixing the wheel hub adaptor 720 on a wheel disc can take place, wherein to do so normal wheel bolts can be used. A rim can be fixed by a central lock on the wheel hub adaptor 720 as a further component, as is explained in more detail by means of FIG. 15.

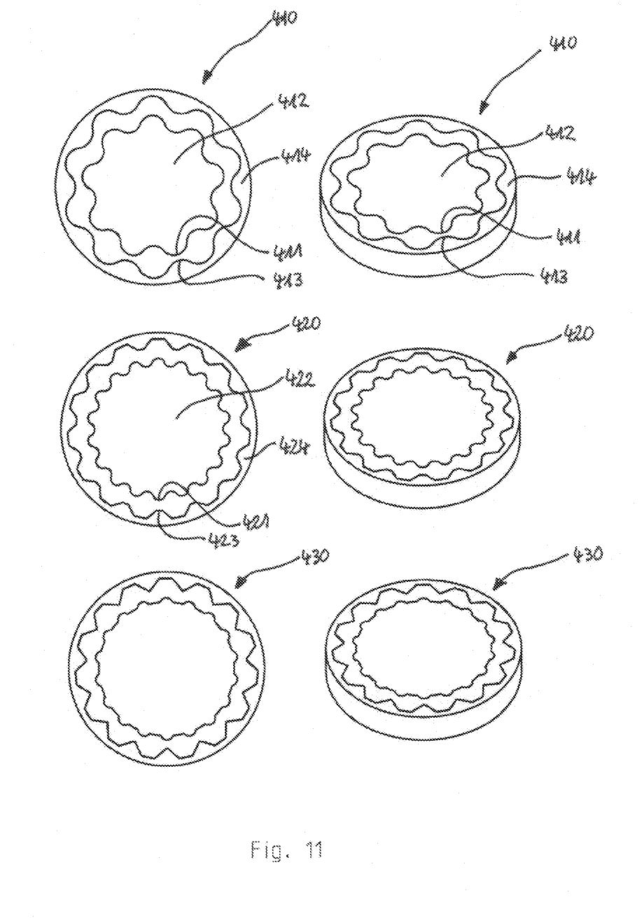

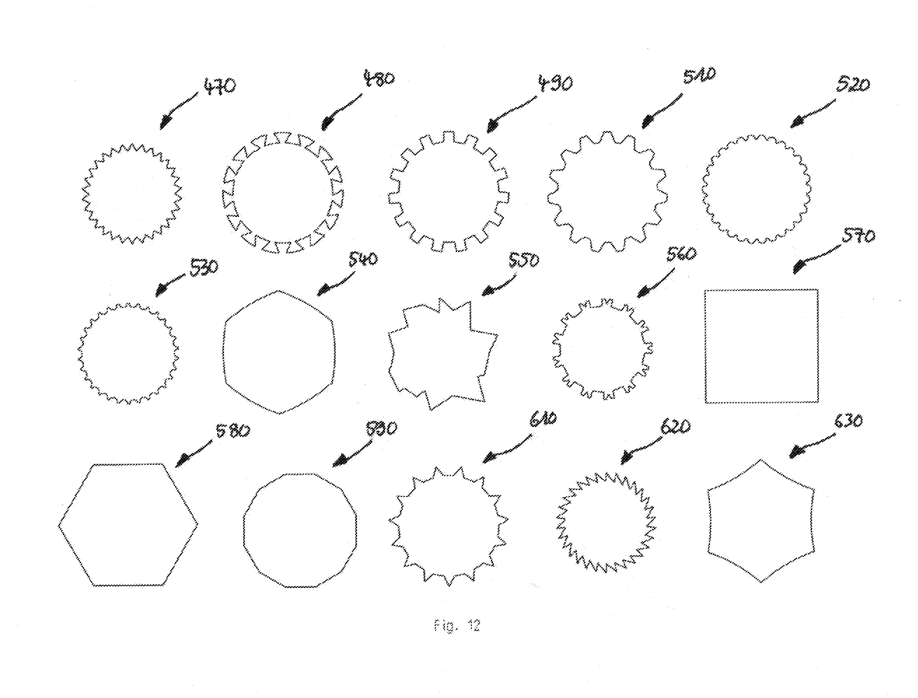

FIG. 14 shows a wheel hub 820 that is adjusted to be used in the securing system according to the invention. The wheel hub 820 is suitable for fixing a normal motor vehicle wheel, wherein the motor vehicle wheel is fixed by a central locking that is secured according to the invention. The wheel hub 820 is provided with an outer thread 823 on the externally protruding, hollow cylinder-shaped extension. On the outer thread 823, a profile 821 along the outer circumference is connected on a terminal section of the extension. A rim of the motor vehicle wheel (not shown) can be fixed on the wheel hub 820 as a further component by a central locking, wherein a clamping nut (central locking—not shown) is threaded that forms a securing gap together with the profile 821 along the outer circumference, a ring-shaped securing element (not shown) according to the invention being inserted into said securing gap for locking the screw connection.

FIG. 15 illustrates fixing a motor vehicle wheel 950 on the wheel hub adaptor 720 in an explosive depiction, wherein the motor vehicle wheel 950 or the rim of the motor vehicle wheel 950 is fixed by a clamping nut 930 set up according to the invention as a central locking. The measurements of the components 720 and 930 are chosen in such a way that, in the assembled state, a securing gap is formed between the profile along the inner circumference 932 of the clamping nut 930 and the profile along the outer circumference 721 of the wheel hub adaptor 720, a securing element 910 according to the principle of the invention being inserted into said securing gap such that the screw connection between the wheel hub adaptor 720 and the clamping nut 930 is locked and secured. Securing the securing element 910 itself in position takes place by means of a further securing bolt 970 that is centrally screwed into an inner thread 770 of the wheel hub adaptor 720 via a thread after assembling the securing element 910.

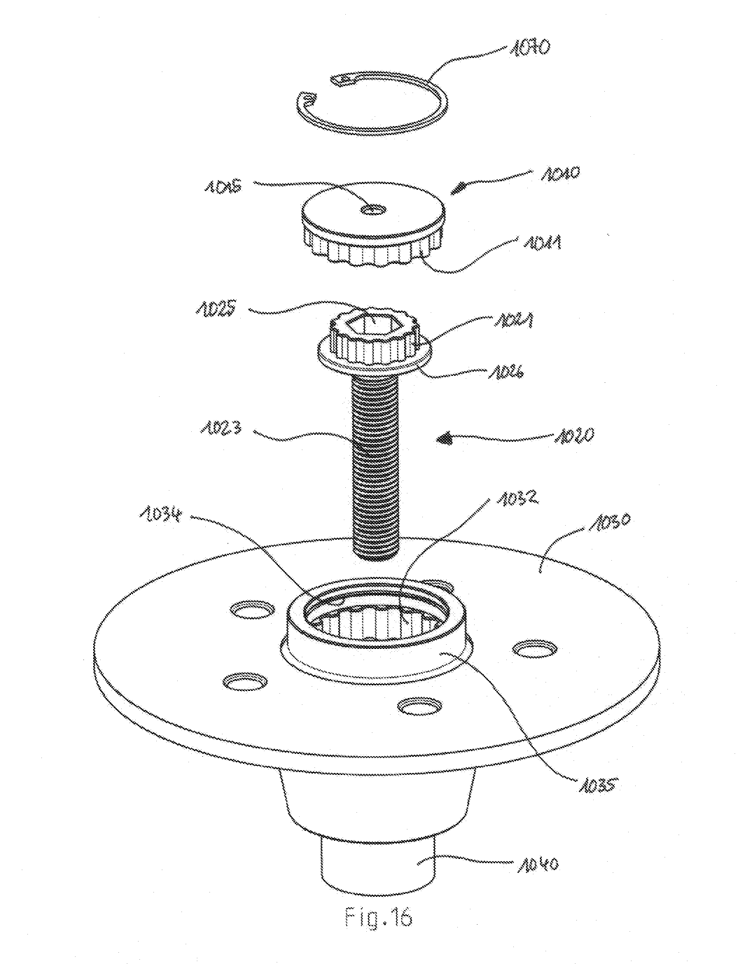

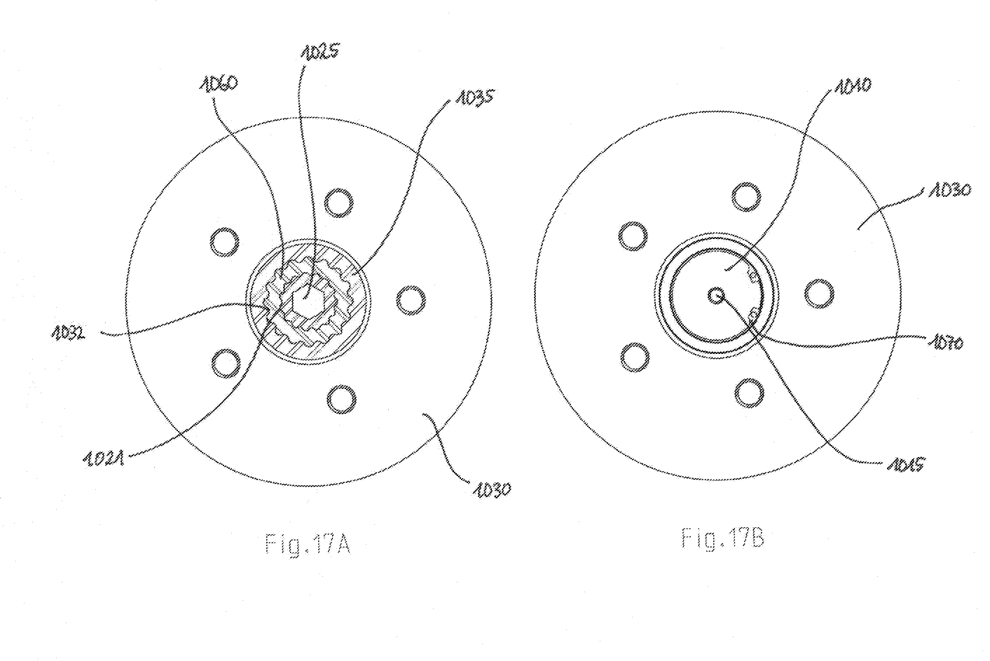

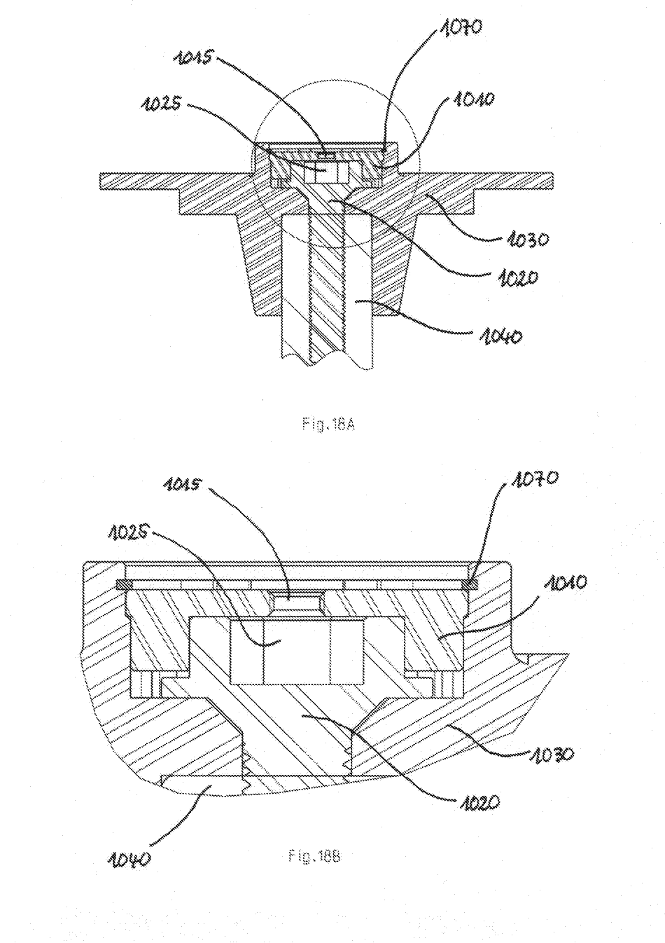

FIG. 16 shows in an explosive depiction the use of the securing system according to the invention for securing a bolt 1020 that represents a first component in the sense of the definitions introduced above. FIG. 17A and 17B show plan views of the system and FIG. 18A and FIG. 18B (enlargement) show sectional views of this system. The different elements of the system according to the invention are provided with the same reference numerals in FIG. 16-18. The bolt 1020 is provided to be screwed into an inner thread of a second component arrangement 1030, 1040 that is not able to be seen by means of an outer thread 1023. In this example, the second component arrangement is a wheel hub that is formed from a flange 1030 (wheel disc) and a shaft 1040. The flange 1030 can be placed on the shaft 1040, for example, by means of a multi gear rim. The shaft 1040 is fitted with the inner thread, wherein the flange 1030 is fixed on the shaft by the bolt 1020. The bolt 1020 having the outer thread 1023 is inserted through the flange 1030 into the inner thread of the shaft 40. This screw connection is locked and secured by the securing system according to the invention. To do so, the bolt 1020 is fitted with a terminally arranged profile 1021 along the outer circumference in its head region. This profile 1021 along the outer circumference forms the terminal outer periphery of the bolt head. The bolt head additionally has a hexagonal socket 1025 that is provided for engaging a bolt tool. Below the region having the profile along the outer circumference 1021, a circular contact plate 1026 is provided that closes the bolt head from below and which protrudes from the circumference towards the region with the externally peripheral profile 1021. The flange 1030 as a component of the second component arrangement 1030, 1040 has a terminal, central and hollow cylinder-shaped region 1035 that is fitted with a profile 1032 along the inner circumference according to the principle according to the invention. When inserting the bolt 1020 into the inner thread of the shaft 1040 and when sinking the bolt 1020 into the flange 1030 until it makes contact with the contact plate 1026, a securing gap 1060 is formed between the profile 1032 along the inner circumference of the flange 1040 and the profile 1021 along the outer circumference of the bolt 1020, said securing gap 1060 being able to be seen in the plan view shown in FIG. 17A. The securing element 1010 is inserted into the securing gap 1060, wherein the number of PFE of the profile along the outer circumference 1011 and the number of PFE of the inner profile of the securing element 1010 that is not able to be seen in FIG. 16 corresponds to the number of PFE of the profile 1032 along the inner circumference of the flange 1030 or the profile 1021 along the outer circumference of the bolt 1020. According to the invention, the number of PFE between the outer profile 1011 and the inner profile of the securing element 1010 differs by at least 1, in this example there are 15 or 16 profile units. A groove ring 1070 is inserted into a peripheral groove 1034 in the inner region of the central hollow cylinder-shaped region 1035 of the flange 1030 to fix the securing element 1010 in place. FIG. 17B shows the assembled state of the system in a plan view, wherein the position of the groove ring 1070 can be seen. As an alternative to the groove ring 1070, a threaded ring, for example, or similar can be inserted. To disassemble the securing element 1010 more easily, the securing element 1010 has a central hole 1015 with an inner thread that is suitable for attaching and disassembling, for example, a threaded rod respectively a sledge hammer.

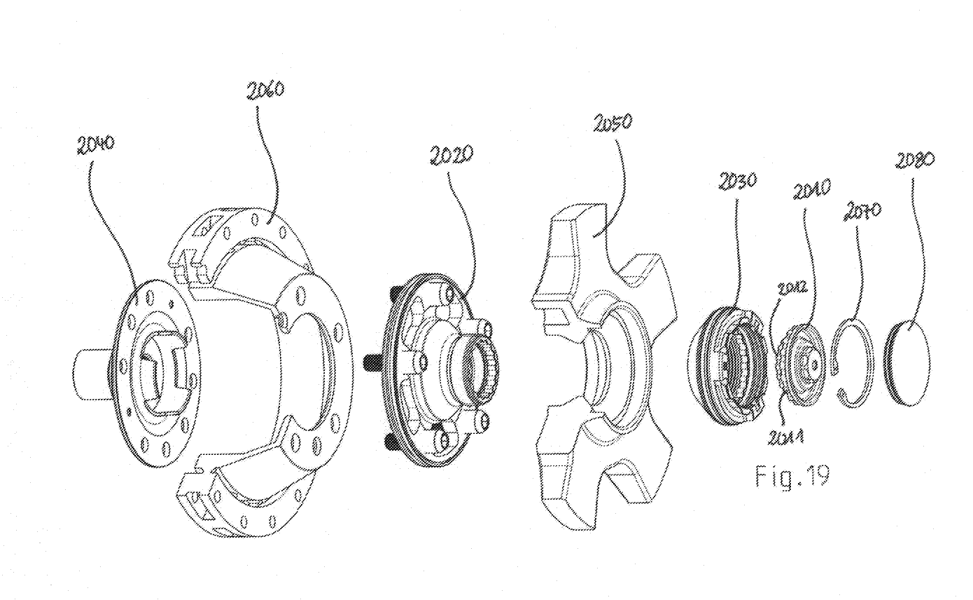

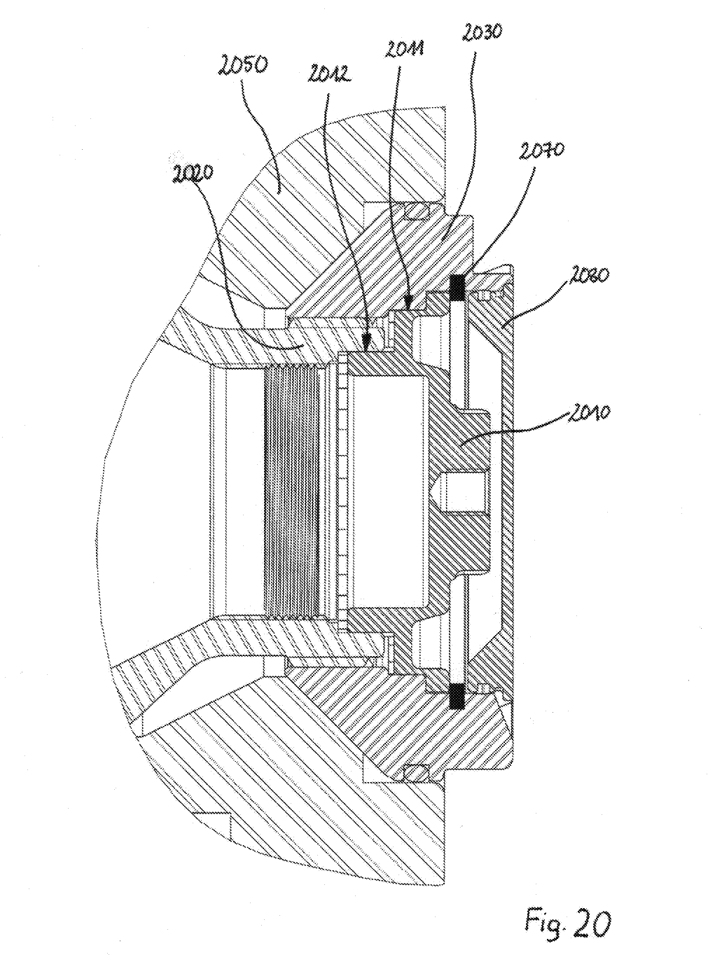

FIG. 19 illustrates in an explosive depiction a further use of the securing system according to the invention for a central locking for a motor vehicle wheel. The depiction shows from left to right a wheel hub 2040, a part of a brake disc 2060, a wheel hub adaptor 2020 having five driving bolts, a rim 2050 (only partially depicted), a clamping nut 2030, a securing element 2010 according to the invention, a snap ring 2070 and a covering plate 2080. In this embodiment, the securing element 2010 is implemented in such a way the outer profile 2011 and the inner profile 2012 are arranged on two different levels of the securing element 2010, i.e. effectively step-shaped. The outer profile 2011 thus runs on a larger circumference than the inner profile. In a corresponding manner, the mirror-inverted profiles with the clamping nut 2030 and the wheel hub adaptor 2020 (first or second component) are also on two levels, in the assembled state of these components, such that the securing element 2010 can be correspondingly inserted and the connection between the clamping nut 2030 and the wheel hub adaptor 2020 is locked. In this embodiment of the securing system according to the invention, the position of the profiles along the outer circumference and along the inner circumference of the first and second component are thus related, in particular, to the position of the profiles with regards to their concentric alignment in the assembled state of the components. Comparable to the embodiment that is illustrated in FIG. 16, the securing element 2010 itself can be secured by the snap ring 2070 (groove ring) and the wheel lock is closed by the covering lid 2080. FIG. 20 shows a sectional depiction of a section of this securing system. The drawing is provided with the same reference numerals.

1. Securing element (10; 110; 210; 910; 1010; 2010) for connecting two components, in particular for a screw connection, wherein the securing element (10; 110, 210; 910; 1010) is ring-shaped and has an outer profile (11; 111; 1011) along the outer circumference and an inner profile (12; 112) along the inner circumference, wherein the outer profile (11; 111; 1011) and the inner profile (12; 112) are each formed from a plurality of profile units, wherein the number of profile units of the outer profile and the number of the profile units of the inner profile correspond to the number of graduation marks with different scales according to the Vernier principle and wherein the number of profile units of the outer profile (11; 111; 1011) and the number of profile units of the inner profile (12; 112) differ by at least 1, and wherein a profile unit of the outer profile (11; 111; 1011) and a profile unit of the inner profile (12; 112) are precisely opposite each other in precisely one position.

2. Securing element according to claim 1, wherein the number of profile units of the outer profile (11; 111) is lower than the number of profile units of the inner profile (12; 112) or the number of profile units of the outer profile is higher than the number of profile units of the inner profile.

3. Securing element according to claim 1, wherein the profile units of the outer profile (11; 111) and/or the inner profile (12; 112) are shaped as waves.

4. Securing element according to claim 1, wherein the lower number of profile units is at least 9 and the higher number of profile units is at least 10.

5. Securing element according to claim 1, wherein the number of profile units of the outer profile (11; 111) and the inner profile (12; 112) differs by precisely 1.

6. Securing element according to claim 5, wherein the lower number of the profile units is 17 and the higher number of the profile units is 18.

7. Securing element (2010) according to claim 1, wherein the outer profile (2011) and the inner profile (2012) run around on different levels of the securing element (2010).

8. Securing element (2010) for connecting two components, in particular for a screw connection, wherein the securing element has a first profile (2011) and a second profile (2012) that each run around on different circumferences on different levels of the securing element, wherein the first profile (2011) and the second profile (2012) are each formed from a plurality of profile units and wherein the number of profile units of the first profile (2011) and the number of profile units of the second profile (2012) correspond to the number of graduation marks with different scales according to the Vernier principle and wherein the number of profile units of the first profile (2011) and the number of profile units of the second profile (2012) differ by at least 1 and wherein a profile unit of the first profile (2011) and a profile unit of the second profile (2012) are precisely opposite each other in precisely one position.

9. Securing system (500; 900) for connecting a first component (20; 120; 220; 720; 1020; 2020) or a first component arrangement and a second component (30; 130; 230; 930; 2030) or a second component arrangement, wherein the first component (20; 120; 220; 720; 1020; 2020) or the first component arrangement has a region having a profile along the outer circumference (21; 121; 221; 721; 1021), and wherein the second component (30; 130; 230; 930; 2030) or the second component arrangement (1030, 1040) has a region having an profile along the inner circumference (32; 132; 232; 932; 1032), and wherein, in the connected state of the components, a ring-shaped gap (160; 260; 1060) is formed between the profile (21; 121; 221; 721; 1021) of the first component (20; 120; 220; 720; 1020; 2020) or the first component arrangement and the profile (32; 132; 232; 932; 1032) of the second component (30; 130; 230; 930; 2030) or the second component arrangement (1030, 1040), further comprising a securing element (10; 110; 210; 910; 1010; 2010) according to claim 1 for arrangement in the securing gap (160; 260; 1060).

10. Securing system according to claim 9, wherein the connection is a screw connection, wherein the first component (20; 120; 220; 720; 1020; 2020) or the first component arrangement has a first thread (23; 123; 223; 723; 1023) and the second component (30; 130; 230; 930; 2030) or the second component arrangement (1030, 1040) has a second thread (33), and wherein, in the screwed-together state of the component, the ring-shaped securing gap (160; 260; 1060) is formed between the profile (21; 121; 221; 721; 1021) of the first component (20; 120; 220; 720; 1020; 2020) or the first component arrangement and the profile (32; 132; 232; 932; 1032) of the second component (30; 130; 230; 930; 2030) or the second component arrangement (1030, 1040) for inserting the securing element (10; 110; 210; 910; 1010; 2010).

11. Securing system according to claim 9, wherein the profile along the outer circumference (21; 121; 221; 721; 1021) of the first component (20; 120; 220; 720; 1020) or the first component arrangement has a number of profile units that corresponds to the number of the profile units of the inner profile (12; 112) of the securing element (10; 110; 210; 910; 1010), wherein the profile along the outer circumference of the first component or the first component arrangement is mirror-inverted relative to the inner profile of the securing element.

12. Securing system according to claim 9, wherein the profile (32; 132; 232; 932; 1032) along the inner circumference of the second component (30; 130; 230; 930) or the second component arrangement (1030, 1040) has a number of profile units that corresponds to the number of profile units of the outer profile (11; 111; 1011) of the securing element (10; 110; 210; 910; 1010), wherein the profile along the inner circumference of the second component or the second component arrangement is mirror-inverted relative to the outer profile of the securing element.

13. Securing system according to claim 9, wherein the securing system further comprises at least one means (25, 70; 124, 170; 224, 270; 970; 1070) for securing the securing element (10; 110; 210; 910; 1010).

14. Use of a securing system (500; 900) according to claim 9 for securing a screw connection for fixing a component (150; 250; 950) provided for a rotating movement, in particular for securing a central lock for a wheel in a motor vehicle.

15. Wheel hub (820; 1030, 1040) or wheel hub adaptor (720), wherein the wheel hub or the wheel hub adaptor is adjusted for use in a securing system according to claim 9.

16. Clamping nut (30; 130; 230; 930), wherein the clamping nut is set up for use in a securing system according to claim 9.

17. Bolt (1020), wherein the bolt is set up for use in a securing system according to claim 9.
